(19) United States
(12) Patent Application Publication
(10) Pub. No.: US 2008/0263917 A1
(43) Pub. Date: Oct. 30, 2008

(54) Calendar Board Which Distinguishes the Holiday and the Normal Day

(76) Inventor: Myeong-i Kwon, Chungcheongbuk-do (KR)

Correspondence Address: DONN K. HARMS;PATENT & TRADEMARK LAW CENTER, SUITE 100, 12702 VIA CORTINA, DEL MAR, CA, 92014, US

(21) Appl. No.: 11/884,593

(22) PCT Filed: Feb. 17, 2006
(86) PCT No.: PCT/KR06/00558

§ 371 Date: Aug. 16, 2007

(30) Foreign Application Priority Data
Feb. 17, 2005 (KR) 20-2005-0004306
Mar. 19, 2005 (KR) 20-2005-0007489

(51) Int. Cl. G09D 3/02

(52) U.S. Cl. 40/110

(57) ABSTRACT

Disclosed therein is a calendar board capable of distinguishing a holiday and an ordinary day with one block. The calendar board includes: a board body in which a magnetic body is embedded and on which a date table is printed, the date table having a month indication section located on the front surface of the board body, an array of day sections located beneath the month indication section for dividing days, arrays of date sections located beneath the array of day sections, and a memo section having a space for allowing a user to take a memo; and thirty-one date blocks respectively bonded on an edge of the upper portion of each section of the arrays of date sections, each date block having two colors printed on both sides thereof for distinguishing a holiday and an ordinary day, each date block being smaller than the memo section formed on the date dividing table. The calendar board can easily distinguish a holiday and an ordinary day by indicating the same date on both sides of one date block with different colors, and prevent inconvenience to use a marker pen since the date block can be detachably attached on the board by using a magnet.

### TECHNICAL FIELD

The present invention relates to a calendar board capable of distinguishing a holiday and an ordinary day with one block, and more particularly, to a block used for realizing a perpetual calendar on a writable board, which has magnetic force and expresses the same date indicated on both sides of the block with different colors, thereby distinguishing a holiday and an ordinary day with one with one block.

### BACKGROUND ART

In general, a board for realizing a perpetual calendar using magnets having a date thereon serves as the perpetual calendar in such a way that rubber magnets, each of which has a date printed on one side thereof, are bonded on edges of sections divided at regular intervals while locations of the rubber magnets are changed whenever the month is changed.

However, such calendar board has several disadvantages in that a user cannot clearly distinguish holidays and ordinary days at a look since the dates written on the magnets are all colored with black, and in that the calendar board cannot secure usefulness in selling on the market since it is not acknowledged in its economical value as the perpetual calendar due to the above disadvantage.

To solve the above problems, Korean Utility Model Application No. 2004-0029310 (entitled “board having calendar function and monthly plan table function” and Korean utility Model Registration No. 20-0373966 (entitled “table calendar having monthly plan table function”, which have been invented by the same inventor as the present invention, respectively disclose a monthly plan board and a table calendar, which can distinguish holidays and ordinary days by providing two date blocks expressing the same date with two colors.

However, such board and calendar also have some disadvantages in that additional space for storing unused date blocks therein is needed, and in that it is possible to frequently loss the date blocks since the unused date blocks are stored in additional space.

### DISCLOSURE OF INVENTION

### Technical Problem

Accordingly, the present invention has been made to solve the above-mentioned problems occurring in the prior art, and it is an object of the present invention to provide a calendar board capable of distinguishing a holiday and an ordinary day with one block, which can distinguish a holiday and an ordinary day by expressing the same date written on both sides of the block with different colors.

### Technical Solution

To accomplish the above object, according to the present invention, there is provided a calendar board capable of distinguishing a holiday and an ordinary day with one block, comprising: a board body in which a magnetic body is embedded and on which a date table is printed, the date table having a month indication section located on the front surface of the board body, an array of day sections located beneath the month indication section for dividing days, arrays of date sections located beneath the array of day sections, and a memo section having a space for allowing a user to take a memo; and thirty-one date blocks respectively bonded on an edge of the upper portion of each section of the arrays of date sections, each date block having two colors printed on both sides thereof for distinguishing a holiday and an ordinary day, each date block being smaller than the memo section formed on the date dividing table.

Reference will be now made in detail to the preferred embodiment of the present invention with reference to the attached drawings.

FIG. 1 is a perspective view of a configuration according to the present invention, FIG. 2 is a perspective view showing the outward appearance of a date block according to a preferred embodiment of the present invention, FIG. 3 is an exploded perspective view of the date block, FIG. 4 is an exploded perspective view showing another coupling method of the date block, FIG. 5 is an exploded perspective view showing a further coupling method of the date block, and FIG. 6 is a perspective view showing a date block according to another preferred embodiment of the present invention.

### BRIEF DESCRIPTION OF THE DRAWINGS

FIG. 1 is a perspective view of a configuration according to the present invention;

FIG. 2 is a perspective view showing the outward appearance of a date block according to a preferred embodiment of the present invention;

FIG. 3 is an exploded perspective view of the date block;

FIG. 4 is an exploded perspective view showing another coupling method of the date block;

FIG. 5 is an exploded perspective view showing a further coupling method of the date block; and

FIG. 6 is a perspective view showing a date block according to another preferred embodiment of the present invention.

### EXPLANATION OF ESSENTIAL REFERENCE NUMERALS IN DRAWINGS

101: block 102: receiving space
103: magnet 104: date
105: opening part 106: color paper
101a,101b: assemblable plate
110c: wall 101d: projection
101e: recess 210: isotropic rubber magnet
220: anisotropic rubber magnet
230: indication part 240: bonding means
250: magnetic plate 251: release paper
252: bonded portion 260: general board
270: package 200: date block

### MODE FOR THE INVENTION

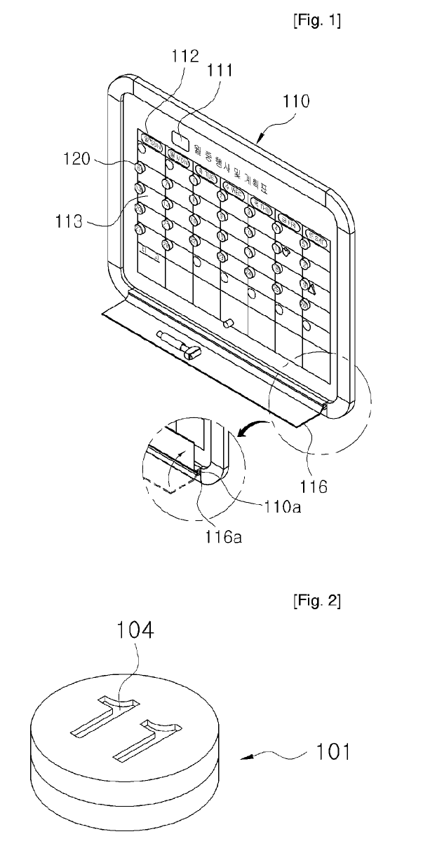

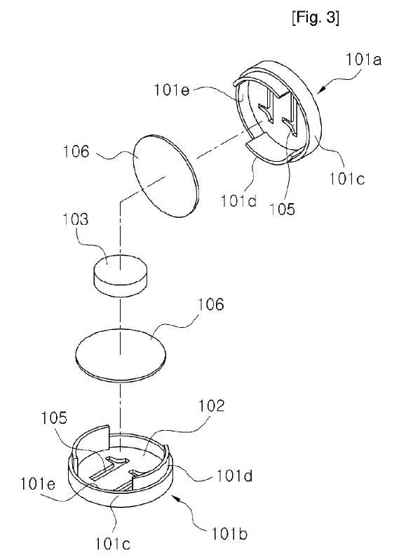

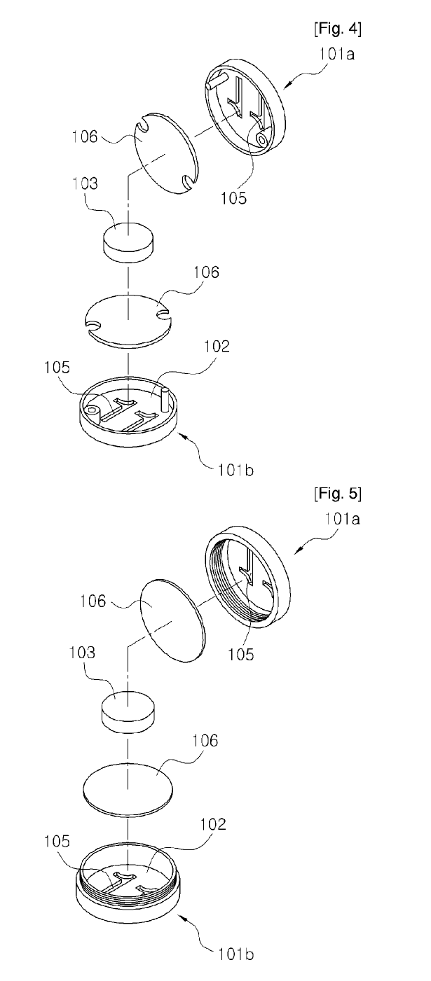

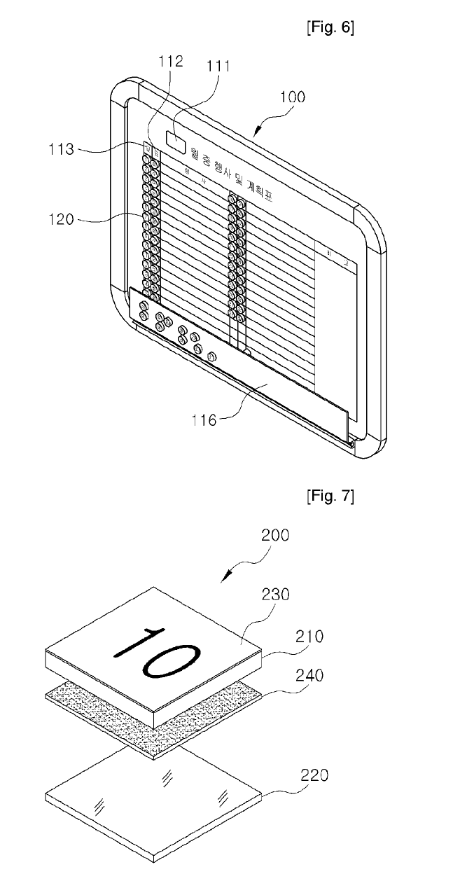

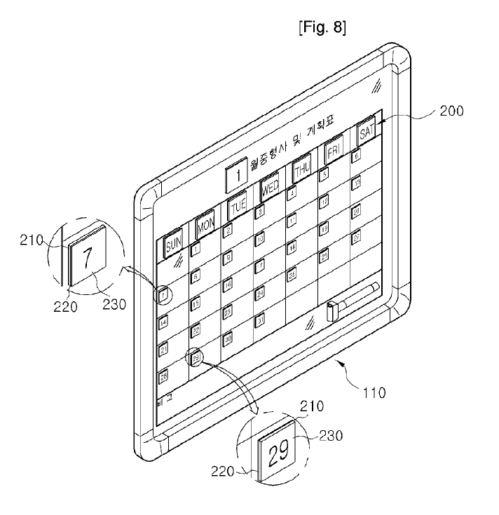

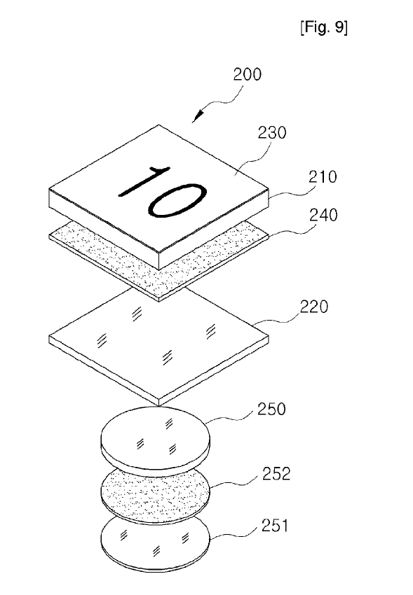

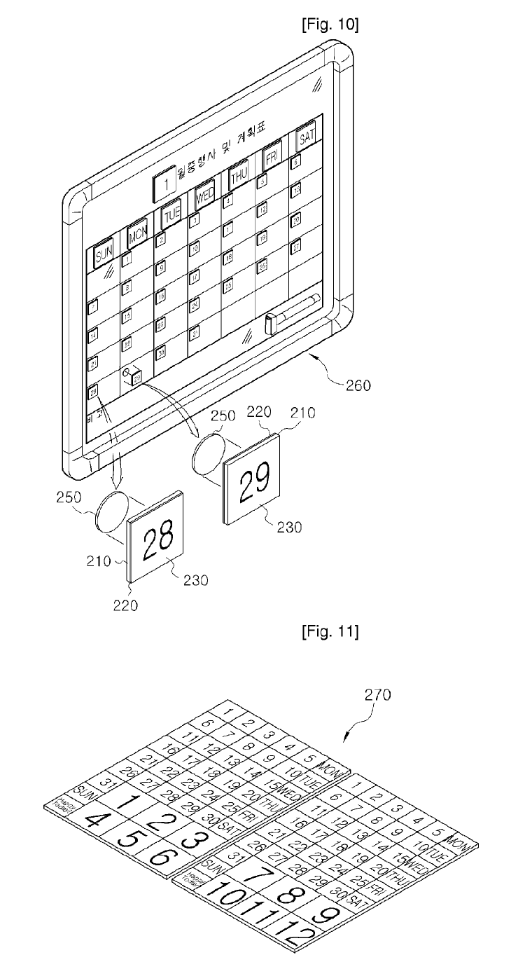

As shown in FIG. 1, the present invention includes a month indication section 111 formed on the front upper portion of a writable board body 110 made of a material to which a magnet can be attached and on which a user can write something with a marker pen, an array of day sections 112 vertically or horizontally divided for indicating days, arrays of date sections 113 formed beneath or next to the array of day sections 112, and date blocks 120 detachably attached on an edge of each date section 113 by magnetic force. The date block 120 is in a form of a block 101, and includes a receiving space 102, a magnet 103 inserted into the receiving space 102 and having a magnetic force and a size as large as the block can be attached to the board body 110, and a date 104 indicated on both sides of the block 101 with different colors.

At this time, the block 101 secures the receiving space 102 by two assemblable plates 101a and 101b engaging with each other, and the assemblable plates 101a and 101b respectively have opening portions 105 opened in the form of the same date. Color papers 106 are disposed at right and left sides of the magnet 103 and inserted into the receiving spaces 102, whereby the same date indicated on both sides of the block 101 is expressed with different colors.

At this time, to secure the receiving space of the block, the block includes a wall 101c injection-molded with a plastic material as high as the receiving space to be secured, and a protrusion 101d and a recess 101e corresponding with each other on the assemblable plate 101a. The assemblable plate 101b has the same form as the assemblable plate 101a, so that the two assemblable plates 101a and 101b are assembled with each other after being respectively injection-molded by just one mold.

Furthermore, the recess and the projection of the assemblable plate respectively have an inward jaw and an outward jaw so as to prevent a free separation from each other after engagement, and such engagement means have been known widely, and can be embodied by one of various known methods.

Alternatively, the wall 101c of the assemblable plate 101a is elongated and has a stepped part formed on the front end thereof and a screw thread formed on the stepped part, and the wall 101c of the assemblable plate 101b corresponding to the assemblable plate 101a has a screw thread formed on the outer periphery thereof, whereby the assemblable plates 101a and 101b are engaged with each other by screw-tightening.

The assemblable plates 101a and 101b can be engaged with each other by one of various known engagement methods since a change of the engagement method does not change the object of the present invention.

Moreover, the assemblable plates 101a and 101b can be assembled with each other by using neodymium for generating a number of magnetic lines so as to obtain strong bonding force without shielding the magnetic lines.

Additionally, the present invention may include a collapsible plate 116 formed on the lower end portion of the board body 110 and being inwardly collapsible toward the board body 110, thereby promoting convenience in use by allowing a user to easily store various blocks for indicating additional commemoration days or other indications.

At this time, the collapsible plate 116 mounted on the lower end portion of the board body 110 has coupling means 116a formed on the upper end portion thereof, and the board body 110 also has coupling means 110a formed on the lower end portion thereof for fixing the collapsible plate 116 thereon by fitting it on the coupling means 110a or detaching the collapsible plate 116 from the board body 110 by drawing out it from the coupling means 110a. The coupling means 116a and 110a are in a hinge type.

As described above, the calendar board according to the present invention has the block 101 having the same date, which is indicated on the both sides thereof with different colors, thereby distinguishing a holiday and an ordinary day with just one block. In more detail, the assemblable plates 101a and 101b constituting the block has the opening part 105 formed in a number for indicating a date, and the color papers 106 of different colors are accommodated in the receiving space 102 of the block 101, whereby the holiday and the ordinary day can be indicated with different colors by exposing the color papers 106 through the opening part 105. Additionally, the present invention can provide an ornamental board since the block can be formed in various shapes.

Furthermore, the board can store the blocks by attaching the block on the collapsible plate 116 in a state where the collapsible plate 116 is inwardly collapsed toward the board body 110, and store writing tools or an eraser for taking a memo on the collapsible plate 116 by unfolding the collapsible plate 116 mounted on the lower end portion of the board, thereby providing convenience in use.

FIG. 7 is an exploded perspective view showing a date block according to another embodiment of the present invention, and FIG. 8 is a view showing a used state of the date block according to the second embodiment of the present invention.

As shown in the drawings, the date block 200 according to the second embodiment of the present invention is a magnet having a number on both sides thereof, and includes an isotropic rubber magnet 210, an anisotropic rubber magnet 220, and bonding means 240 for bonding the rubber magnets with each other.

The isotropic rubber magnet 210 is a common magnet which is generally used as stationery articles and simply attached on something without strong magnetic force or precision. Such isotropic rubber magnet is manufactured by a press process after adding magnetic powder particle, such as ferrite powder, with rubber material.

The anisotropic rubber magnet 220 is manufactured by giving a uniform directionality to ferrite powder particles, which are mixed with the rubber material, by mounting a magnetic field during a process for pressing out a rubber magnet. Such anisotropic rubber magnet is commonly used in precision instruments, such as motors, duplicators, and television sets.

In general, the isotropic rubber magnet 210 and the anisotropic rubber magnet 220 have different magnetic forces, i.e., a weak magnetic side and a strong magnetic side. Particularly, the isotropic rubber magnet 210 has a side which has strong magnetic force and the other side which has little magnetic force. In such rubber magnet, generally, the strong magnetic side is used for attachment, and the weak magnetic side is used for indicating a printed matter. Moreover, the strong magnetic side can be treated with UV coating so as to prevent coloring of the board on which the rubber magnet is attached.

In the present invention, the strong magnetic sides of the isotropic rubber magnet 210 and the anisotropic rubber magnet 220 are used as an indication part 230 in order to increase bonding force on both sides thereof. To increase bonding force on both sides of the indication part 230, the isotropic rubber magnet 210 and the anisotropic rubber magnet 220 are bonded with each other. At this time, since the strong magnetic sides of the isotropic rubber magnet 210 and the anisotropic rubber magnet 220 are the indication parts 230 and the weak magnetic sides thereof are bonded with each other, the both sides of the indication part 230 has increased bonding force, whereby the both sides of the indication part 230 can be bonded.

As described above, when the weak magnetic sides of the isotropic rubber magnet 210 and the anisotropic rubber magnet 220 are bonded with each other, the rubber magnets can be easily bonded since they do not have the same polarity. On the contrary, when the strong magnetic sides of the isotropic rubber magnet 210 and the anisotropic rubber magnet 220 are bonded with each other, since the rubber magnets push to each other due to existence of the same polarity on the rubber magnets, a product manufactured by the above bonding of the rubber magnets is deteriorated in quality and outward appearance. Furthermore, since the weak magnetic sides become the indication part 230 if the strong magnetic sides are bonded with each other, bonding force of the indication part 230 is lowered. Since the both sides of the block according to the present invention must be used all, the weak magnetic sides of the rubber magnets 210 and 220 are bonded with each other so that the strong magnetic sides become the indication parts 230.

The indication part 230 is a sticker on which a colored number or character is printed, and adhered on the isotropic rubber magnet 210 and the anisotropic rubber magnet 220. At this time, the indication parts 230 of different colors are respectively adhered on the isotropic rubber magnet 210 and the anisotropic rubber magnet 220 to distinguish them from each other. The indication parts 230 used on the board body 110 have the same number printed with two colors to distinguish a holiday and an ordinary day, and preferably, thirty-one indication parts 230 are prepared for indicating holidays and ordinary days without regard to months. In addition, the indication parts 230 can be used as pieces in games which is played by using two or more colors, namely, a game of chess or a game of yut (Korean traditional game). Alternatively, the indication part 230 may have a side on which a Chinese character or an English word is printed and the other side on which a Korean word is printed so as to improve children s study effect.

Moreover, the present invention can prevent coloring of the board body 110 due to a long-term bonding of the rubber magnets since the indication parts 230 disposed on the rubber magnets 210 and 220 are bonded on the board body 110 and so the rubber magnets are not directly bonded on the board body 110.

The bonding means 240 is to bond the weak magnetic sides of the isotropic rubber magnet 210 and the anisotropic rubber magnet 220 with each other so that the strong magnetic sides of the isotropic rubber magnet 210 and the anisotropic rubber magnet 220 indicate the numbers or characters or are bonded on the board. At this time, the bonding means 240 may be double-coated adhesive tape or adhesives.

FIG. 9 is an exploded perspective view showing a date block according to a third embodiment of the present invention, and FIG. 10 is a view showing a used state of the date block according to the third embodiment of the present invention.

As shown in FIG. 9, in the third embodiment of the present invention, the date block 200 is a magnetic body which can be bonded on not only a magnetic board but also a general board 260, and includes a magnetic plate 250 disposed on the rear surface thereof. The magnetic plate 250 includes a bonded portion 252 having a release paper 251 so as to be bonded on the general board 260. The bonded portion 252 is bonded on the rear surface of the magnetic plate 250, and double-coated adhesive tape or adhesives may be coated thereon. The release paper 251 is disposed on the rear surface of the bonded portion 252 in order to prevent lowering of bonding force of the bonded portion 252 or damage of the bonded portion 252.

FIG. 11 is a perspective view showing a package for assembling the date blocks according to the present invention.

As shown in FIG. 11, the package 270 includes the isotropic rubber magnet 210 and the anisotropic rubber magnet 220 having the indication parts 230, and the bonding means 240, and so, the user can assemble the rubber magnets to have the same number on the both sides thereof. As described above, the packaged calendar block according to the present invention can greatly improve children s study, for example, memorizing of Chinese characters or English words, study of properties of magnets, or study of numbers or a calendar.

In the embodiments of the present invention, the date blocks according to the present invention indicate dates, days, and commemoration days, but the present invention is not restricted to the above embodiments, and can be applied widely, for example, attachment to a refrigerator door, a computer, a duplicator or a cooling fan, various advertisements, sign boards, letter boards for education, or others.

While the present invention has been described with reference to the particular illustrative embodiments, it is not to be restricted by the embodiments but only by the appended claims.

### INDUSTRIAL APPLICABILITY

As described above, the present invention can distinguish the holiday and the ordinary day with one date block by indicating the same date on both sides of the date block with different colors, and secure economic efficiency and usefulness on the market since it is simple manufactured.

1. A calendar board capable of distinguishing a holiday and an ordinary day with one block, the calendar board comprising: a board body in which a magnetic body is embedded and on which a date table is printed, the date table having a month indication section located on the front surface of the board body, an array of day sections located beneath the month indication section for dividing days, arrays of date sections located beneath the array of day sections, and a memo section having a space for allowing a user to take a memo; and thirty-one date blocks respectively bonded on an edge of the upper portion of each section of the arrays of date sections, each date block having two colors printed on both sides thereof for distinguishing a holiday and an ordinary day, each date block being smaller than the memo section formed on the date dividing table.

2. The calendar board capable of distinguishing a holiday and an ordinary day with one block according to claim 1, wherein the date block is a double-side numbered magnet, and includes: an isotropic rubber magnet having an indication portion formed on a strong magnetic side thereof on which a number or a character is printed; an anisotropic rubber magnet having an indication portion formed on a strong magnetic side thereof on which a number or a character is printed; and bonding means for bonding a weak magnetic side of the isotropic rubber magnet with a weak magnetic side of the anisotropic rubber magnet.

3. The calendar board capable of distinguishing a holiday and an ordinary day with one block according to claim 1, wherein the date block includes: a receiving space formed therein; and a magnet inserted into the receiving space and having magnetic force as strong as the block can be bonded on the board, and wherein the block has the same number indicated on both sides thereof with different colors.

4. The calendar board capable of distinguishing a holiday and an ordinary day with one block according to claim 3, wherein the date block includes: two assemblable plates engaging with each other, the two assemblable plates respectively having opening parts formed thereon in the same number shape; and color papers of different colors disposed at right and left of the magnet and inserted into the receiving space.

5. The calendar board capable of distinguishing a holiday and an ordinary day with one block according to claim 3, wherein the magnet is a neodymium magnet having strong magnetic force.

6. The calendar board capable of distinguishing a holiday and an ordinary day with one block according to claim 4, wherein the magnet is a neodymium magnet having strong magnetic force.
